(19) United States
(12) Patent Application Publication
(10) Pub. No.: US 2002/0154967 A1
(43) Pub. Date: Oct. 24, 2002

(54) Claw-type fixer for holding a vamp and a midsole

(76) Inventor: Hsi-Mou Huang, Ping-Chen City (TW)

Correspondence Address: Steven J. Hultquist, Intellectual Property/Technology Law, P.O. Box 14329, Research Triangle Park, NC, 27709, US

(21) Appl. No.: 09/839,278

(22) Filed: Apr. 20, 2001

(51) Int. Cl. F16B 15/00

(52) U.S. Cl. 411/461

(57) ABSTRACT

A claw-type fixer for temporarily holding a vamp and a midsole of a shoe during a manufacturing process is introduced. The claw-type fixer is made of a steel plate to form a claw structure that includes a claw handle and a plurality of front teeth curved 90° from the claw handle. Each of the teeth has a sharp tip for easily piecing the leather-made vamp. While applying the claw-type fixer of the present invention, the left hand of the operator is used to hold the claw handle of the fixer and the right hand is used to depress the teeth of the fixer into the work piece. The claw-type fixer can ensure temporarily the connection of the vamp and the midsole and thus improve the adhesion in between. While removing the fixer of the present invention, it can be easily done by simply applying little pulling upon the handle to lift the claw-type fixer. In addition, the claw-type fixer is low-cost and can be reused.

### BACKGROUND OF THE INVENTION

(1) Field of the Invention

The invention relates to a claw-type fixer for holding a vamp and a midsole in a shoe manufacturing process, and more particularly to a one-piece claw structure which provides sharp teeth to ensure the holding of the vamp and the midsole.

(2) Description of the Prior Art

In the shoe industry, a shoe manufacturing process may include a step of preparing a wooden shoetree, a step of temporarily fixing a midsole to a bottom of the shoetree (in a shoe structure, a bottom of a shoe can include three top layers of innersole, a middle layer of midsole and a bottom layer of bottomsole), a step of sleeving an edge-folded vamp onto the shoetree to form a structure as shown in FIG. 1, and a step of holding the vamp together with the midsole by a sewing or gluing method.

In the art of shoe manufacturing, the gluing method for holding the vamp and the midsole together is mostly and commonly seen. In a traditional application of gluing, the well-known instant glue is seldom used for its difficulty in timing application. On the other hand, the gradual-drying adhesive is usually utilized in the shoe manufacturing industry.

While using the gradual-drying adhesive to integrate the vamp and the midsole, either by wind-drying or by stove-drying, the unhardened adhesive at the early stage cannot provide sufficient adhesion between the vamp and the midsole so that the adhesion mechanism in between is easy to be broken. As long as the adhesion mechanism is broken, the residue adhesive on the vamp or on the midsole is hard to be removed and, definitely, the removing work of the residue adhesive is difficult and time-consuming.

Therefore, in the art, while applying the gradual-drying adhesive, a substantial amount of pins are used to confirm the adhesion between the vamp and the midsole in the early stage of gluing. Nevertheless, as long as the pins are fixed, it is hard to pull them off the vamp and the midsole without damaging the vamp.

### SUMMARY OF THE INVENTION

Accordingly, it is a primary object of the present invention to provide a claw-type fixer to replace the conventional pins for holding the vamp and the midsole.

While applying the fixer, the left hand of the operator is used to hold a handle of the fixer and the right thumb is used to depress a handle of the fixer. Preferably, a small-size hammer can be used to secure the fixer. While removing the fixer of the present invention, it can be easily done by simply applying little pulling upon the handle to lift the fixer.

All these objects are achieved by a claw-type fixer described below.

### BRIEF DESCRIPTION OF THE DRAWINGS

The present invention will now be specified with reference to its preferred embodiment illustrated in the drawings, in which

FIG. 1 shows a planar vamp after tailoring for an ordinary shoe;

FIG. 2 shows how the vamp of FIG. 1 is placed onto a shoetree;

FIG. 3 illustrates a preferred embodiment of the claw-type fixer in accordance with the present invention by four enlarged planar plots; and

FIG. 4 is a perspective view of the preferred embodiment of FIG. 3.

### DESCRIPTION OF THE PREFERRED EMBODIMENT

The invention disclosed herein is directed to a claw-type fixer for holding a vamp and a midsole. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

Referring now to FIG. 1, a planar form of a vamp 1 for a shoe is shown. In a typical shoe manufacturing process, the vamp 1 as shown is firstly tailored, and then the edge 11 of the vamp 1 is hemmed in and sew the vamp 1 together at the heels 12.

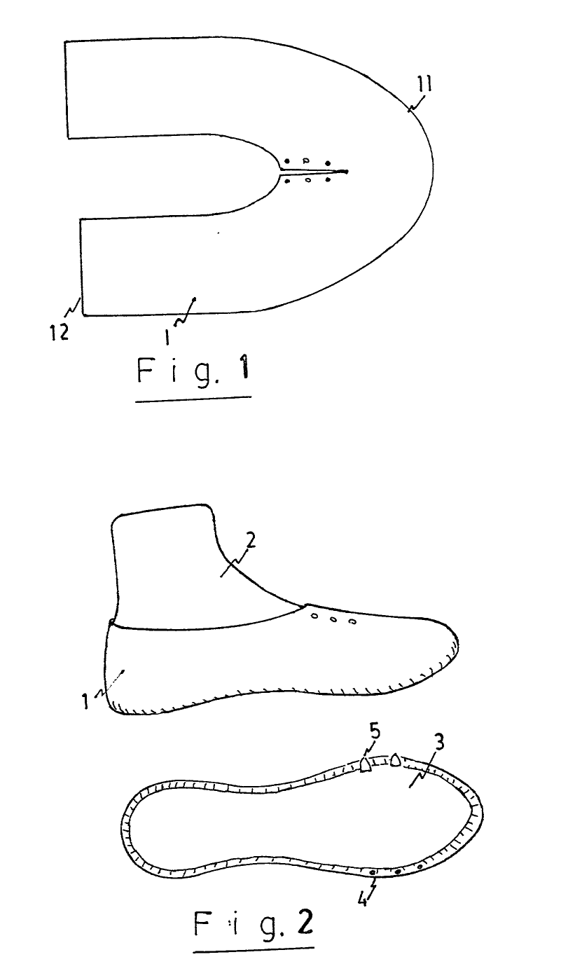

Referring now to FIG. 2, the sewed vamp 1 is shown to be mounted onto a shoetree 2. Prior to the placement of the vamp 1, a midsole 3 is temporarily located to the bottom of the shoetree 2. The vamp 1 is then glued to the midsole 3. As described in previous sections, a gradual-drying glue instead of an instant glue is used for the gluing between the vamp 1 and the midsole 3. Also, it is stated that the vamp 1 and the midsole 3 might fall apart wholly or partly during the glue drying. To ensure the connection of the vamp 1 and the midsole 3, a plurality of nails 4 are usually used to perform the temporary fixation in between. As long as the gluing therebetween is done, the nails can be pulled off by a nail puller. It can be foreseen that the application of the nails 4 is labor-consuming and also has a great possibility of the nail puller damaging the edge 11 of the vamp 1.

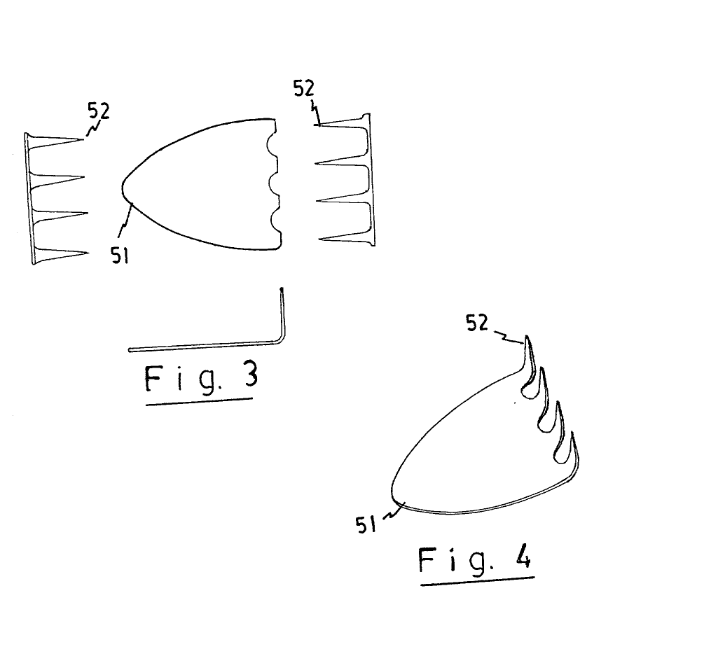

Referring now to FIG. 3 and FIG. 4, a preferred embodiment of the claw-type fixer in accordance with the present invention is shown. In practice, the total length of the fixer excluding the curved portion might be only 2 centimeters. The fixer, made of elastic thin steel plate, includes a handle 51 at one side thereof (left side as shown in figures) and a plurality of sharp tips 52 formed as parallel teeth at another side (right side as shown in figures).

While an operator applying the fixer 5 of the present invention, left-hand fingers are used to hold the handle 51 and right-hand fingers are used to depress the tips 52 into the edge 11 of the vamp 1 as shown in FIG. 2. To ensure the depressing of the fixer 5 into some hard parts of the vamp 1, a small-sized hammer can be used to guarantee the application of the fixer 5.

After the gluing between the edge 11 of the vamp I and the midsole 3 is done, the fixers 5 can be easily removed by a small-size puller or even by fingers. The pulled-off fixers 5 can then be collected and stored for a next application. It is obvious that, by applying the fixer of the present invention, the cost for temporary fixation between the vamp 1 and the midsole 3 as well as the possibility of the vamp 1 damage during the pulling-off can be greatly reduced.

As described above, the claw-type fixer 5 in accordance with the present invention for temporarily holding a vamp 1 and a midsole 3 of a shoe during a manufacturing process is disclosed, in which the fixer 5 can be made of a steel plate to form a claw structure and has a plurality of front teeth with respective tips 52 and preferably curved 90° from the handle 51.

While the present invention has been particularly shown and described with reference to a preferred embodiment, it will be understood by those skilled in the art that various changes in form and detail may be without departing from the spirit and scope of the present invention.

I claim:

1. A claw-type fixer for temporarily holding a vamp and a midsole of a shoe during a manufacturing process, the fixer being made of a steel plate to form a claw structure having thereof a plurality of front teeth curved 90° from a claw handle thereof, each of the teeth having a sharp tip.
